(19) United States
(12) Patent Application Publication
(10) Pub. No.: US 2026/0140961 A1
(43) Pub. Date: May 21, 2026

(54) DATA MINING METHOD AND COMPUTER SYSTEM FOR DATA MINING

(71) Applicants: Inventec (Pudong) Technology Corp., Shanghai (CN); Inventec Corporation, Taipei (TW)

(72) Inventors: Wei-Chao Chen, Taipei (TW); Ming-Chi Chang, Taipei (TW)

(73) Assignees: Inventec (Pudong) Technology Corp., Shanghai (CN); Inventec Corporation, Taipei (TW)

(21) Appl. No.: 19/231,594

(22) Filed: Jun. 9, 2025

(30) Foreign Application Priority Data
Nov. 18, 2024 (CN) 202411651907.4

(51) Int. Cl. G06F 16/2458; G06F 16/22; G06F 16/28

(52) U.S. Cl. CPC G06F 16/2465; G06F 16/221; G06F 16/285

(57) ABSTRACT

A data mining method includes extracting a main character column of a data table of a data sheet; determining an evaluation measurement value of the data table according to a variance and an outlier ratio of the main character column of the data table; and determining a data mining value of the data table according to the evaluation measurement value of the data table.

### BACKGROUND OF THE INVENTION

### 1. Field of the Invention

The present invention relates to a data mining method and a related computer system, and more particularly, to a data mining method and a related computer system capable of reducing the cost of data mining.

### 2. Description of the Prior Art

Data mining is a process to find valuable information from data. However, since the high volume of big data, the hardware cost, pre-processing cost of data and the risk of failure of data mining increase. For example, an ordinary computer cannot execute the data mining process, the missing values and the outliers of the data sheet increase the loading of the pre-processing of data, which dramatically increases the cost of data mining.

Therefore, in order to reduce the cost of data mining of big data, improvements are necessary to the conventional techniques.

### SUMMARY OF THE INVENTION

Therefore, the present invention provides a datamining method and a related computer system to determine the value of the data sheet so as to decrease the cost of data mining.

An embodiment of the present invention discloses a data mining method, comprises extracting a main character column of a data table of a data sheet; determining an evaluation measurement value of the data table according to a variance and an outlier ratio of the main character column of the data table; and determining a data mining value of the data table according to the evaluation measurement value of the data table.

Another embodiment of the present invention discloses a computer system for data mining, comprises a processing device; and a memory device, coupled to the processing device, configured to store a program code for instructing the processing device to execute a data mining process, wherein the process comprises extracting a main character column of a data table of a data sheet; determining an evaluation measurement value of the data table according to a variance and an outlier ratio of the main character column of the data table; and determining a data mining value of the data table according to the evaluation measurement value of the data table.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a computer system according to an embodiment of the present invention.

FIG. 2 is a schematic diagram of a data mining process according to an embodiment of the present invention.

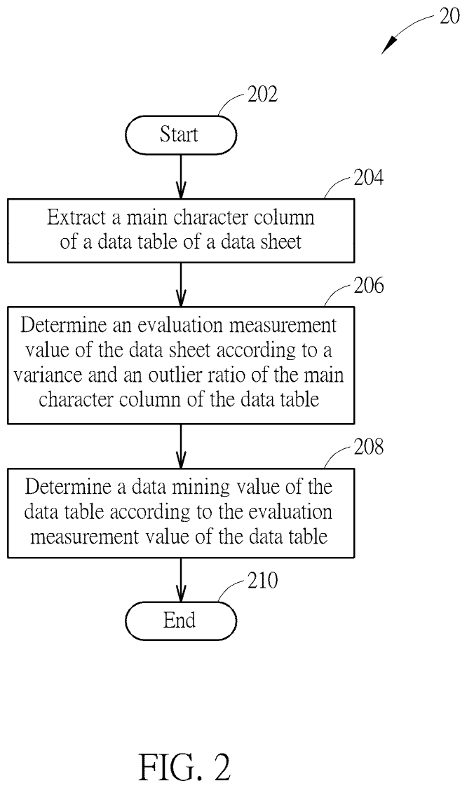

FIG. 3 is a schematic diagram of a flowchart of determining a main character column of the data sheet according to an embodiment of the present invention.

FIG. 4 is a schematic diagram of an evaluation process of the data mining according to an embodiment of the present invention.

FIG. 5 is a schematic diagram of a generation process of a data mining recommendation table according to an embodiment of the present invention.

### DETAILED DESCRIPTION

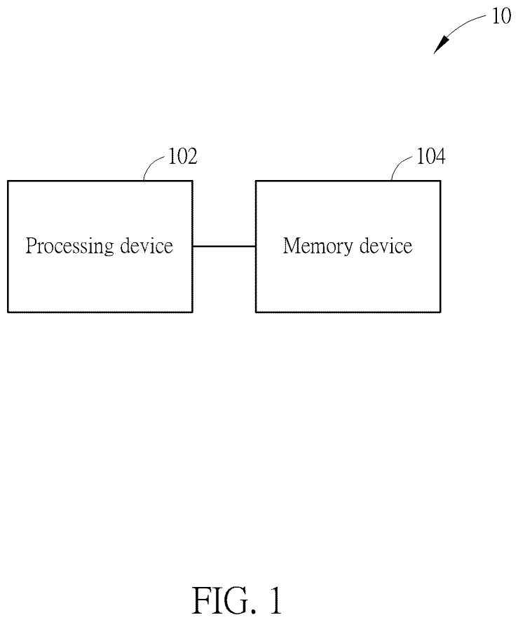

Please refer to FIG. 1, which is a schematic diagram of a computer system 10 according to an embodiment of the present invention. The computer system 10 is utilized for data mining, which includes a processing device 102 and a memory device 104. The memory device 104 is coupled to the processing device 102, configured to store a program code for instructing the processing device 102 to execute a data mining process 20. The data mining process 20 is utilized for performing the data mining for the data stored in the data center, wherein the data center may include the data sheet. Thus, the data mining process 20 may determine the value of data mining according to the quality of the data tables of the data sheet to increase the efficiency of the data mining. The data mining process 20 includes the following steps:
Step 202: Start;
Step 204: Extract a main character column of a data table of a data sheet;
Step 206: Determine an evaluation measurement value of the data sheet according to a variance and an outlier ratio of the main character column of the data table;
Step 208: Determine a data mining value of the data table according to the evaluation measurement value of the data table.
Step 210: End.

The data mining process 20 may determine the data mining value of massive data. That is, the data mining process 20 according to an embodiment of the present invention may determine whether the data sheet is worthy of the data mining or not with only numerical values of the data quality of the data sheet without detailed information.

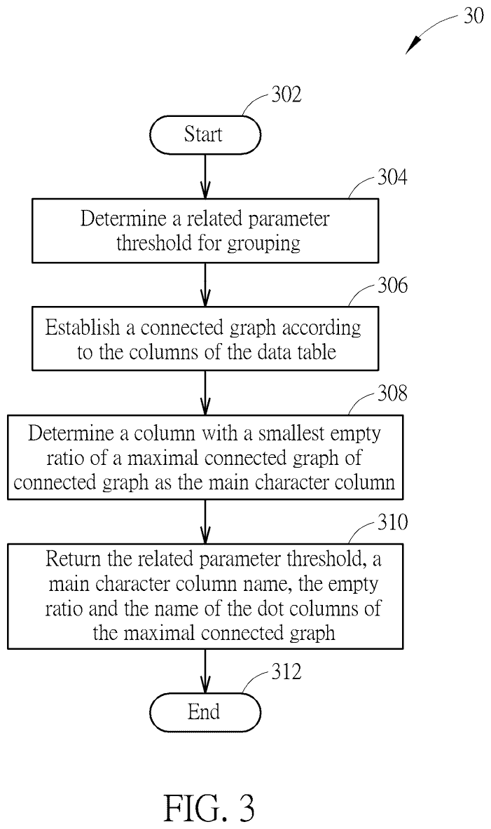

In step 204, the computer system 10 extracts the main character column of the data table of the data sheet. In detail, since the data table includes multiple columns, e.g., the data sheet is formed by a joint method of multiple data tables, the data mining process 20 according to an embodiment of the present invention may group the columns into multiple groups according to related parameters of the data sheet. Then, a representative column is selected in each group based on the empty ratio. In an embodiment, the representative column is the main character column of the data table. A flowchart 30 of determining the main character column of the data table is concluded. As shown in FIG. 3, the flowchart 30 includes the following steps:
Step 302: Start;
Step 304: Determine a related parameter threshold for grouping;
Step 306: Establish a connected graph according to the columns of the data table;
Step 308: Determine a column with a smallest empty ratio of a maximal connected graph of connected graph as the main character column;
Step 310: Return the related parameter threshold, a main character column name, the empty ratio and the name of the dot columns of the maximal connected graph.
Step 312: End.

Notably, each dot of the connected graph represents each column of the data table in step 306, a line formed by two dots (i.e., columns) represents that an absolute value of the related parameter is not smaller than the related parameter threshold, which is determined in step 304. In addition, since the smallest column of the empty ratio of step 308 may be more than one, the user may determine an optimal column as the main character column according to different application requirements. For example, when the user is in Taiwan, the column of total amount with the currency value of New Taiwan dollar (NTD) is selected as the main character column; when the user is in the U.S., the column of total amount with the currency value of United States dollar (USD) is selected as the main character column.

In another embodiment, the user may randomly select a column as the main character column. In another embodiment, when no empty ratio exists in the maximal connected graph, a center point of the maximal connected graph may be selected as the main character column, i.e., the least dots to the farthest dots.

In order to evaluate whether the data sheet is worthy of the data mining or not, the data mining process 20 according to an embodiment of the present invention may utilize the main character column of the data table of the data sheet as an important basis for the evaluation.

The data mining process 20 determines the evaluation measurement value of the data table according to the variance and the outlier ratio of the main character column of the data table in step 206. The variance or the standard deviation may reflect a volatility of the data sheet. When the numerical value of the variance is larger, the volatility of the data is higher. Under this situation, the future data cannot be precisely predicted when the volatility of the data is too high, i.e., the data mining value of columns of the data sheet is relatively low.

The value of the outlier ratio represents data types of the column. When the value of the outlier ratio is higher, a diversity of the data is higher. Under this situation, the future data cannot be precisely predicted when the value of the outlier ratio is too high, i.e., the data mining value of the column of the data sheet is relatively low.

Therefore, with the relationship of the variance, the outlier ratio and the columns of the data sheet may be concluded as a measurement M, which satisfies the following formula (1):

$$M ∝ {F}_{Var} ( \frac{1}{variance} ) or M ∝ {F}_{UR} ( \frac{1}{outlier ratio} ) \qquad ( 1 )$$

wherein Fᵥₐᵣ and F_{UR} are non-negative increasing functions.

In an embodiment, the measurement M may be the following formula (2):

$$M ( variance , outlier ratio ) = K \frac{1}{variance \times outlier ratio} \qquad ( 2 )$$

wherein K is a normalized measurement positive constant.

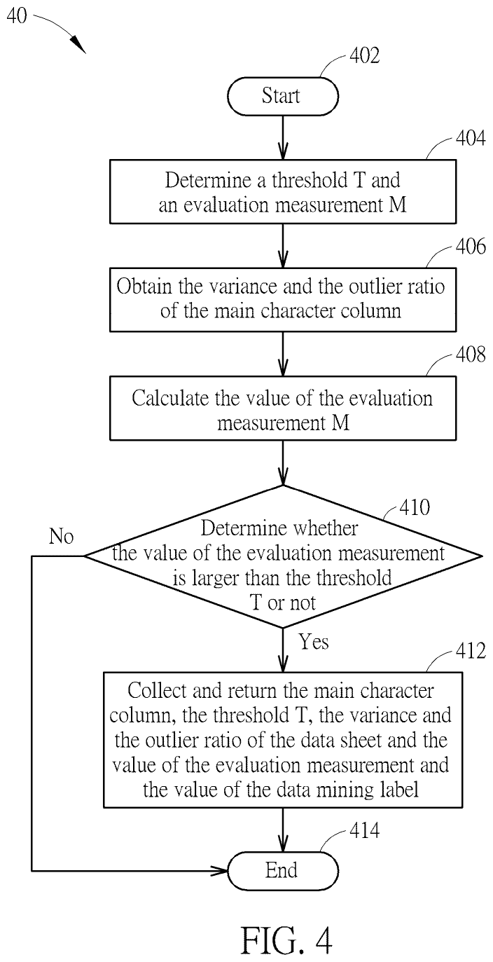

Please refer to FIG. 4, which is a schematic diagram of an evaluation process 40 of the data mining according to an embodiment of the present invention. The evaluation process 40 is utilized for determining whether the main character column is worthy of the data mining or not according to the main character column of the data sheet.

The evaluation process 40 includes the following steps:
Step 402: Start;
Step 404: Determine a threshold T and an evaluation measurement M;
Step 406: Obtain the variance and the outlier ratio of the main character column;
Step 408: Calculate the value of the evaluation measurement M;
Step 410: Determine whether the value of the evaluation measurement is larger than the threshold T or not, if yes, a value of the data mining label is True, if not, the value of the data mining is False;
Step 412: Collect and return the main character column, the threshold T, the variance and the outlier ratio of the data sheet and the value of the evaluation measurement and the value of the data mining label;
Step 414: End.

Notably, the evaluation measurement M of step 404 determines the measurement of formula (1) or (2) or other combinations of formulas, such that the value of the evaluation measurement M is determined in step 408. In addition, the value of the data mining label in step 410 is for labeling the data sheet, such that the computer system 10 may determine whether to adopt the data sheet or not according to the value of the data mining label for the massive data.

### Use Gap Code

After the step 204 and step 206, the data mining process 20 determines the data mining value of the data table according to the evaluation measurement value of the data sheet according to the evaluation measurement value the data table in step 208, i.e., the related parameter threshold, the name of the main character column, the empty ratio and column names of all dots of the maximal connected graph.

Since the synchronicity and the predictability of the data are important information for data mining, wherein the synchronicity denotes that a meaningful correlation exists between events without causation, and the predictability denotes the estimation, analysis or deduction for the future variation according to experiences or data in the past.

Therefore, the data mining process 20 according to an embodiment of the present invention may perform the data mining value measurement (DMVM) according to the synchronicity and the predictability of the data sheet. When the data mining value measurement (DMVM) value of the data sheet is higher, the data mining value of the synchronicity or the predictability is higher. The data mining value measurement (DMVM) is shown as a formula (3):

$$DMVM = {\sum }_{{Column ∈}_{main character column}} \text{?}$$

$$\text{?} \text{indicates text missing or illegible when filed}$$

The formula (3) is utilized for calculating the summation of a dot number of the main character column of the maximal connected graph of the data sheets labeled as True of the data mining label.

In another embodiment, the data mining value measurement (DMVM) may be shown as formulas (4), (5):

$$DMVM = {\sum }_{{Column ∈}_{main character column}} \text{?} \qquad ( 4 )$$

$$DMVM = {\sum }_{{Column ∈}_{main character column}} \text{?}$$

$$\text{?} \text{indicates text missing or illegible when filed}$$

Alternatively, the dot number of the maximal connected graph of the main character column may be a weighting for the value of the measurement evaluation, and may be summed with multiple or exponential, which may be the basis for determining the data mining value measurement (DMVM).

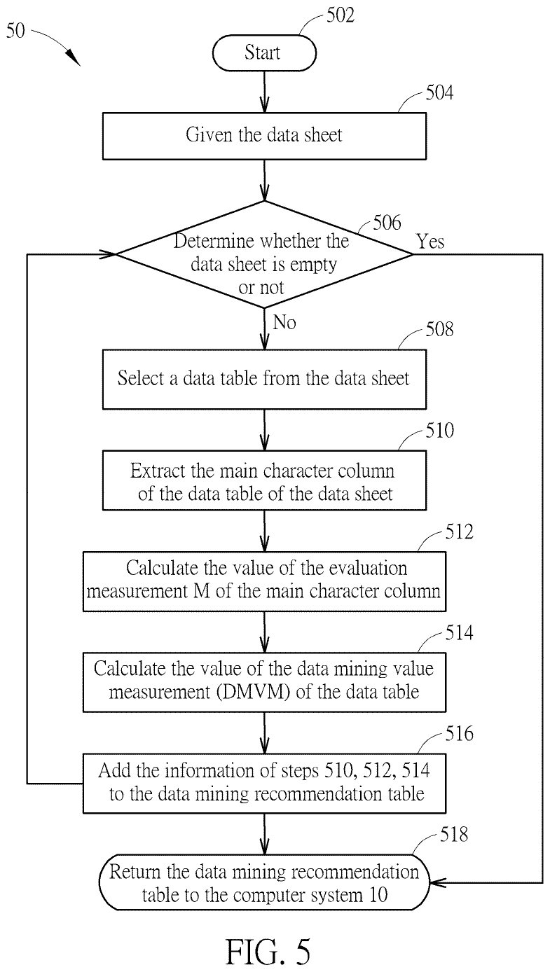

Please refer to FIG. 5, which is a schematic diagram of a generation process 50 of a data mining recommendation table according to an embodiment of the present invention. The generation process 50 of the data mining recommendation table includes the following steps:
Step 502: Start;
Step 504: Given the data sheet;
Step 506: Determine whether the data sheet is empty or not, if yes, go to step 520, if not, go to step 508;
Step 508: Select a data table from the data sheet;
Step 510: Extract the main character column of the data table of the data sheet;
Step 512: Calculate the value of the evaluation measurement M of the main character column;
Step 514: Calculate the value of the data mining value measurement (DMVM) of the data table;
Step 516: Add the information of steps 510, 512, 514 to the data mining recommendation table;
Step 518: Return the data mining recommendation table to the computer system 10.

Therefore, the data mining recommendation table generated by the generation process 50 may be a config file, such that the computer system 10 may perform the data mining for all data sheets of the database of the data center to achieve the automatic analysis for big data.

In an embodiment, the computer system 10 may present the data mining recommendation table via an application programming interface (API). For example, the user may evaluate the predictability for the main characteristic with the settings of the candidate model or measurement via the API to generate corresponding predictability and synchronicity evaluation of the data sheet. Then, the evaluation is provided to the user.

Notably, those skilled in the art may make proper modifications. For example, the evaluation measurement formulas, the data mining value measurements, and are not limited thereto and can be modified according to different user's requirements or system settings, which are all within the scope of the present invention.

In summary, the present invention provides a data mining method and related computer system, which determines the data mining value of the data sheet of massive data to achieve the goal of the automatic analysis of big data of the database of the data center.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A data mining method, comprising:
extracting a main character column of a data table of a data sheet;
determining an evaluation measurement value of the data table according to a variance and an outlier ratio of the main character column of the data table; and
determining a data mining value of the data table according to the evaluation measurement value of the data table.

2. The data mining method of claim 1, wherein the step of extracting the main character column of the data table of the data sheet includes the following steps:
grouping a plurality of columns of the data table into a plurality of groups according to a related parameter threshold of the data table;
establishing a connected graph according to the plurality of groups; and
determining the main character column of the data table according to a maximal connected graph of the connected graph and an empty ratio of the data table.

3. The data mining method of claim 2, wherein the main character column is a column with a smallest the empty ratio of the maximal connected graph.

4. The data mining method of claim 2, wherein the step of determining the data mining value of the data table according to the evaluation measurement value of the data table comprises:
determining a data mining value measurement value of the data mining value of the data table according to a dot number of the maximal connected graph, the related parameter threshold and the empty ratio of the data table.

5. The data mining method of claim 4, further comprising:
generating a data mining recommendation table associated with the data sheet according to the data mining value measurement value.

6. A computer system for data mining, comprising:
a processing device; and
a memory device, coupled to the processing device, configured to store a program code for instructing the processing device to execute a data mining process, wherein the process comprises:
extracting a main character column of a data table of a data sheet;
determining an evaluation measurement value of the data table according to a variance and an outlier ratio of the main character column of the data table; and
determining a data mining value of the data table according to the evaluation measurement value of the data table.

7. The computer system for data mining of claim 6, wherein the step of extracting the main character column of the data sheet of the data table of the data mining process comprises:
grouping a plurality of columns of the data table into a plurality of groups according to a related parameter threshold of the data table;
establishing a connected graph according to the plurality of groups; and
determining the main character column of the data table according to a maximal connected graph of the connected graph and an empty ratio of the data table.

8. The computer system for data mining of claim 7, wherein the main character column is a column with a smallest the empty ratio of the maximal connected graph.

9. The computer system for data mining of claim 7, wherein the step of determining the data mining value of the data table according to the evaluation measurement value of the data mining process comprises:
determining a data mining value measurement value of the data mining value of the data table according to a dot number of the maximal connected graph, the related parameter threshold and the empty ratio of the data table.

10. The computer system for data mining of claim 9, wherein the data mining process further comprises:
generating a data mining recommendation table associated with the data sheet according to the data mining value measurement value.
